(19) United States
(12) Patent Application Publication
(10) Pub. No.: US 2007/0292724 A1
(43) Pub. Date: Dec. 20, 2007

(54) System and method to start a fuel cell stack during a cold-start condition

(76) Inventor: Ian T. Gilchrist, Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/454,620

(22) Filed: Jun. 16, 2006

(51) Int. Cl. H01M 16/00; H01M 8/04; H02J 7/00; H01M 10/50

(52) U.S. Cl. 429/9; 320/101; 429/23; 429/24; 429/62; 429/13

(57) ABSTRACT

A system and method for operating a fuel cell stack and at least one battery during at least a cold-start condition includes operating a fuel cell stack at a reduced voltage during the cold-start condition, and/or sourcing pulsating current to a battery during the cold-start condition.

### BACKGROUND OF THE INVENTION

1. Field of the Invention

This disclosure generally relates to electrical power systems, and more particularly to fuel cell systems.

2. Description of the Related Art

Electrochemical fuel cells convert reactants, namely fuel and oxidant fluid streams, to generate electric power and reaction products. Electrochemical fuel cells generally employ an electrolyte disposed between two electrodes, namely a cathode and an anode. An electrocatalyst, disposed at the interfaces between the electrolyte and the electrodes, typically induces the desired electrochemical reactions at the electrodes.

In a fuel cell stack, a plurality of fuel cells are connected together, typically in series, to increase the overall output power of the assembly. During normal operation of a fuel cell stack, fuel is electrochemically reduced on the anode side, typically to generate protons, electrons, and possibly other species depending on the fuel employed. The protons are conducted from the reaction sites at which they are generated, through the membrane, to electrochemically react with oxygen in the oxidant on the cathode side. The electrons travel through an external circuit providing useable electrical power and then react with the protons and oxygen on the cathode side to generate by product (e.g., water).

Conventional fuel cells operate at a relatively high minimum stack and/or cell voltage during normal operating temperatures. For example, in some automotive applications, a fuel cell stack provides a nominal output direct current (DC) voltage of 240 volts at 300 amps. Individual, serially-connected fuel cells of the fuel cell stack may, for example, output a nominal voltage of approximately 0.65 volts per fuel cell during normal operating temperatures.

However, during fuel cell start-up conditions, initial start-up voltages may be significantly less than the voltages provided from the fuel cell during normal operation. That is, the process of initially injecting fuel and/or oxidant into the fuel cell and starting the energy conversion process may take some discernable amount of time as voltage and/or current levels increase up to normal operating conditions.

For example, a fuel cell stack may provide an output voltage of 100 to 150 volts at a relatively low current. Individual, serially-connected fuel cells of the fuel cell stack may, for example, only output a voltage of approximately 0.2 to 0.4 volts per fuel cell during start-up conditions. During a cold-start condition, fuel cell stack output will be significantly less.

A cold-start condition may occur when, for example, ambient temperatures are below a minimum start-up operating temperature of the fuel cell and/or a battery (which may be less than the minimum normal operating temperature of the fuel cell and/or battery). Cold-start conditions may be significant issues in northern regions of the U.S., Canada, or other areas during the winter months where near-freezing or below-freezing ambient temperatures occur. As noted above, one significant factor affecting the start-up period is the initial temperature of the fuel cells when the start-up process is initiated. During a cold-start condition, the electrochemical reaction process is very electrically inefficient such that relatively low voltage at relatively small current output is available from the fuel cell. That is, if the initial fuel cell temperature is less than the minimum start-up operating temperature, time is required for the operating temperature of the fuel cell to increase to at least the minimum start-up operating temperature. Accordingly, a start-up period is required before sufficient voltage and current are available from the fuel cell stack.

It is known to take measures to provide heat to the fuel cells during a cold-start condition to expedite the start-up process. For example, an auxiliary heater device may be used to heat up the fuel cell stack. It is also known to operate the fuel cells at a reduced voltage. Operating at reduced voltage produces heat for the fuel cells through relatively high internal power losses occurring during reduced voltage operation.

Batteries may also be used in conjunction with fuel cell systems as another source of power. During a start-up process, the battery may be used to power various controllers and/or processors, or to provide a relatively larger initial source of power until the fuel cell system temperature reaches normal operating conditions. The amount of power provided by the batteries during various stages of operation of the power system is variable and depends on the hybridization strategy used in the power system.

However, when a battery is operated at a cold temperature, battery output current is significantly less than the amount of available output current provided from the battery during normal operating temperatures. It is known to take measures to provide heat to the battery when the battery is cold. For example, an auxiliary heater device may be used to heat up the battery. It is also known to temporarily operate the battery using a pulsating current to provide heat to the battery. Operating a battery with pulsed current produces heat through relatively high internal power losses. It is also known to heat the battery by providing either alternating current (AC) power or direct current (DC) power to the battery.

Power systems using power provided by a fuel cell stack and/or a battery may not become operational until the fuel cell stack and/or battery are capable of providing sufficient power. An example of a device having at least a fuel cell stack and a battery for providing electric power is an electric hybrid vehicle. During a cold winter morning, in the absence of special actions to increase operating temperatures of the fuel cell stack and/or battery, the electric vehicle will be inoperable until the fuel cell stack and/or battery have reached their minimum start-up operating temperature. From a consumer's point of view, relatively long waits until the electric vehicle may be used are simply unacceptable. It may also prove more efficient to shorten the start up time of a hybrid fuel cell-battery system.

Although there have been advances in the field, there remains a need in the art for increasing efficiency and for reducing cold-start times of a power system employing both fuel cells and batteries. The present disclosure addresses these needs and provides further related advantages.

### BRIEF SUMMARY OF THE INVENTION

A system and method for operating a power supply system during a cold-start condition are disclosed. Briefly described, in one aspect, an embodiment may be summarized as a system comprising a fuel cell stack electrically operable to produce direct current (DC) power, a power conversion system electrically coupled to the fuel cell stack and operable to receive DC power from the fuel cell stack, at least one battery electrically coupled to the power conversion system and operable to exchange battery DC power with the power conversion system, and a controller operable to control operation of the power supply system such that at least an amount of pulsating current is supplied to the battery during the cold-start condition.

In another aspect, an embodiment may be summarized as a method for operating a fuel cell stack and at least one battery during at least a cold-start condition, the method comprising operating the fuel cell stack at a reduced start-up direct current (DC) voltage during the cold-start condition so that excess heat generated within the fuel cell stack during the cold-start condition increases a temperature of the fuel cell stack, wherein the reduced start-up DC voltage is less than a nominal DC voltage received from the fuel cell stack during a normal operating condition, and sourcing the at least one battery with pulsating current during the cold-start condition so that excess heat generated within the battery during the cold-start condition increases a temperature of the battery, wherein DC power from the fuel cell stack is converted into at least a portion of the pulsating current sourced to the battery.

In another aspect, an embodiment may be summarized as a method for operating a fuel cell stack and at least one battery during at least a cold-start condition, the method comprising receiving direct current from at least one fuel cell of the fuel cell stack during the cold-start condition, converting at least a portion of the received direct current into pulsating current, and providing the pulsating current to the battery during at least a portion of the cold-start condition so that excess heat is generated within the battery during the cold-start condition to increase a temperature of the battery.

In another aspect, an embodiment may be summarized as a system for operating a fuel cell stack and at least one battery during at least a cold-start condition, comprising a means for operating the fuel cell stack at a reduced start-up direct current (DC) voltage during the cold-start condition so that excess heat generated within the fuel cell stack during the cold-start condition increases a temperature of the fuel cell stack, wherein the reduced start-up DC voltage is less than a nominal DC voltage received from the fuel cell stack during a normal operating condition; a means for receiving a direct current from the fuel cell stack during the cold-start condition; a means for converting at least a portion of the received DC current into alternating current; and a means for providing the alternating current to the battery during at least a portion of the cold-start condition so that excess heat is generated within the battery during the cold-start condition to increase a temperature of the battery.

### BRIEF DESCRIPTION OF THE SEVERAL VIEWS OF THE DRAWINGS

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is a block diagram of a power system employing an exemplary embodiment of a fuel cell and battery cold-start system.

FIG. 2 is a block diagram of an alternative embodiment of a cold-start system.

FIG. 3 is a block diagram of another alternative embodiment of a cold-start system.

FIG. 4 is a block diagram of yet another alternative embodiment of a cold-start system.

FIG. 5 is a block diagram of an alternative embodiment of a cold-start system employing a frequency converter.

FIG. 6 is a block diagram of an alternative embodiment employing a battery charger.

FIGS. 7-8 are flowcharts illustrating embodiments of a process for increasing fuel cell stack temperature and battery temperature during a cold-start condition.

### DETAILED DESCRIPTION OF THE INVENTION

In the following description, certain specific details are set forth in order to provide a thorough understanding of various embodiments. However, one skilled in the art will understand that the invention may be practiced without these details. In other instances, well-known structures associated with power converters, controllers and/or gate drives have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open sense, that is as “including, but not limited to.”

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

As noted above, during a cold-start condition, the electrochemical reaction process within a fuel cell is very inefficient such that relatively low voltage and relatively small current output is available from the fuel cell. Also, when a battery is operated at a cold temperature, battery output current is significantly less than the amount of available current provided from the battery during normal operating temperatures. Accordingly, generating heat within both the fuel cell and battery during a cold-start condition is desirable in that operating capability of both the fuel cell and battery will more quickly improve as temperature rises to normal operating conditions. Accordingly, when the fuel cell and/or battery operating temperatures have increased up to at least some minimum operating temperature, sufficient power may then be available from the fuel cell and/or battery for operating a power system.

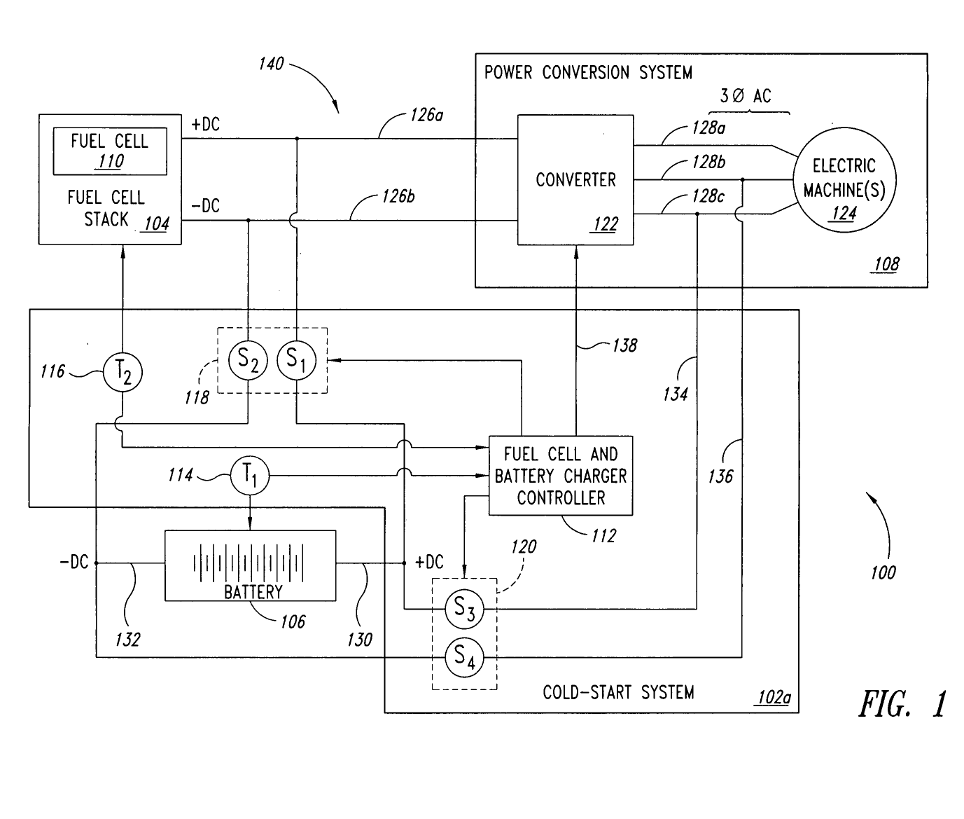

FIG. 1 is a block diagram of a power system 100 employing an exemplary embodiment of a cold-start system 102a. Cold-start system 102a is electrically coupled to the fuel cell stack 104 and battery 106. The fuel cell stack 104 and battery 106 are electrically coupled to the power conversion system 108. In a preferred embodiment, the fuel stack 104 is comprised of one or more individual fuel cells 110 electrically coupled together. Some power systems 100 may employ a plurality of fuel cell stacks 104.

The cold-start system 102a increases the operating temperature of the fuel cell stack 104 by operating the fuel cell stack 104 at a reduced voltage. Also, the cold-start system 102a increases the operating temperature of the battery 106 during a cold-start condition by providing a time varying or pulsating current to the battery 106. The pulsating current may take the form of an alternating current (AC), may be a pulsating type of DC current, or may be DC current modulated by an AC current signal or other type of pulsed current signal. A non-limiting example of pulsating DC current may be generated with a switch device that repeatedly opens and closes in a periodic or nonperiodic manner. Any suitable time varying current having a wave form whose duration is short compared to a time-scale interest may be used such that the time varying or pulsed current generates heat within the battery 106.

In this exemplary embodiment, alternating current (AC) power is provided to the battery 106 through a power conversion system 108. Preferably, the AC power is supplied, at least in part, by DC power generated by the fuel cell stack 104.

The cold-start system 102a comprises a fuel cell and battery charger controller 112, a temperature sensor 114 operable to sense temperature of the battery 106 or ambient environment proximate the battery 106, a temperature sensor 116 operable to sense temperature of the fuel cell stack 104 or ambient environment proximate the fuel cell stack 104, a first set of switches 118 (S1, S2), and a second set of switches 120 (S3, S4). The fuel cell and battery charger controller 112 is controllably coupled to the first set of switches 118 (S1, S2) and second set of switches 120 (S3, S4) such that the fuel cell and battery charger controller 112 controls operation of the switches S1-S4. The switches S1-S4 may be switched into open positions (open circuit) or closed positions (short circuit) in response to control signals from the fuel cell and battery charger controller 112. In an alternative embodiment, one or more temperature sensors communicatively coupled to the controller that are operable to sense ambient temperature and/or temperature within the power system 100 could be used so that the fuel cell and battery charger controller 112 determines an occurrence of the cold-start condition.

Embodiments of the cold-start system 102a are electrically coupled to a power conversion system 108. In the illustrated exemplary embodiment of FIG. 1, cold-start system 102 is coupled to a power conversion system 108 comprising a converter 122 and one or more electric machines (e.g., motors and/or generators) 124. Converter 122 is operable to receive direct current (DC) power from fuel cell stack 104, via connections 126a, 126b. Converter 122 converts DC power received from the fuel cell stack 104 into AC power, for example, three phase (3φ) AC power.

As illustrated in FIG. 1, converter 122 is electrically coupled to a load, such as the illustrated electric machine 124 operated as a motor during the cold-start condition, via connections 128a, 128b, 128c. In this simplified example, connection 128a corresponds to the Aφ connection to the electric machine 124. Connection 128b corresponds to the Bφ connection to the electric machine 124. Connection 128c corresponds to the Cφ connection to the electric machine 124.

Power conversion system 108 is intended to be a simplified illustrative system wherein at least one source of AC current is available for the cold-start system 102a, as described in greater detail below. Other types of power conversion systems 108 may employ single phase (1φ) AC power. Some power conversion systems 108 may not employ any AC power, but rather, utilize only DC power. Embodiments of the cold-start system 102 operable with these various types of power conversion systems 108 are described hereinbelow.

Exemplary uses of power conversion system 108 may include, but are not limited to, providing electric power for an electric vehicle 140 that employs the fuel cell stack 104 as an energy source. Accordingly, power conversion system 108 may receive DC power from the fuel cell stack 104. The converted AC power provides electric power to the electric machine 124 for propulsion of the electric vehicle. It is appreciated that other components may reside in the power conversion system 108 that are not illustrated. For example, other power sources, such as gas engines or the like, may provide energy to the power conversion system 108. Other components may include a control system (not shown) for controlling operation of the converter 122 and/or electric machine 124 and/or fuel cell stack 104 including reactant and oxidant supply systems.

The above-described power conversion system 108 is intended as a simplified exemplary system that converts DC power from the fuel cell stack 104 into a form that may be useable by one or more loads. The power conversion system 108 may be part of an integrated power train (IPT) which powers an electric vehicle or the like.

The illustrated electric machine(s) 124 are intended as exemplary load devices. Other types of power conversion systems 108 may source one or more other types of AC and/or DC load devices. Further, some types of power conversion systems 108 may use DC power directly from the fuel cell stack 104 without current and/or voltage conversion. In yet other embodiments, other power sources may be integrated into the power system 100, such as gasoline engines, ultra-capacitors and/or super-capacitors. If the power system 100 powers an electric vehicle, the electric machines 124 may themselves become power sources when operated in a regenerative mode during a braking operation. It is intended that all such various types of power conversion systems 108, which are too numerous to be conveniently described in detail herein, are included within the subject matter of this disclosure.

During normal system operation of the power system 100, the first set of switches 118 (S1, S2) are operated in a closed position such that the positive terminal 130 of battery 106 and the negative terminal 132 of battery 106 are electrically coupled to the corresponding DC connections 126a, 126b of the fuel cell stack 104. Accordingly, in this exemplary embodiment, the battery 106 operates at the same DC voltage as the fuel cell stack 104.

When the power system 100 is initially started, temperature sensor 114 senses the operating temperature of battery 106 and temperature sensor 116 senses the operating temperature of fuel stack 104. In the event that the sensed temperature of the battery 106 and/or the fuel cell stack 104 are at least equal to their respective minimum start-up operating temperature, the fuel cell and battery charger controller 112 recognizes or determines an absence of a cold-start condition. Accordingly, the power system 100 may be started with the first set of switches 118 (S1, S2) closed to electrically couple the battery 106 to at least the DC portion of power conversion system 108 or the output of the fuel cell stack 104. The second set of switches 120 (S3, S4) are opened such that the battery 106 is electrically decoupled from the AC portion of power conversion systems 108. Such operating conditions may occur, for example, during the summer when ambient temperatures are relatively warm.

Alternatively, temperature sensor 114 may indicate that the operating temperature of the battery 106 is less than its minimum start-up operating temperature. In that event, the second set of switches 120 (S3, S4) are operated in a closed position to electrically couple the battery to connections 128b, 128c. Further, the first set of switches 118 (S1, S2) are operated in an open condition to electrically decouple the battery to connections 126a, 126b. In this exemplary embodiment, switch S3 is electrically coupled to connection 128c and switch S4 is electrically coupled to connection 128b, via connections 134 and 136, respectively.

In various embodiments, converter 122 is operated to produce AC current. Passing the AC current through battery 106 causes the battery operating temperature to increase. When the operating temperature of battery 106 increases to at least the minimum start-up operating temperature, the fuel cell and battery charger controller 112 causes the second set of switches 120 (S3, S4) to open and the first set of switches 118 (S1, S2) to close. Accordingly, the AC current is no longer provided to the battery 106 through the second set of switches 120 (S3, S4). The battery 106 becomes electrically coupled to the connections 126a and 126b through the first set of switches 118 (S1, S2) such that normal operation of the battery 106 may occur.

In alternative embodiments, the switches S3 and S4 may be electrically coupled to any of the AC connections 128a, 128b, or 128c. In other embodiments, switches S3 and S4 may be coupled to other AC connections (not shown) in the power conversion system 108. Such other AC connections may provide AC power to other types of three-phase and/or single-phase loads in the power conversion system 108.

Concurrently, temperature sensor 116 may indicate that the operating temperature of the fuel cell stack 104 is less than its respective minimum start-up operating temperature (which may be different from the minimum start-up operating temperature of the battery 106). In that event, the fuel cell stack 104 is operated in a reduced voltage condition such that excess heat is generated as a result of the low operating efficiency induced by the low operating voltage of the fuel cell stack 104. In this exemplary embodiment, the fuel cell and battery charger controller 112 is controllably coupled to the converter 122. The fuel cell and battery charger controller 112 communicates control signals to components (not shown) in the converter 122, or other components (not shown) in the power conversion system 108, which cause the fuel cell stack 104 to operate at the reduced voltages during the above-described cold-start condition.

Various techniques are available to operate the fuel cell stack 104 at reduced voltages to generate excess heat for increasing the temperature of the fuel cell stack. One exemplary apparatus and system is described in U.S. Pat. No. 6,329,089, entitled “Method and Apparatus For Increasing The Temperature Of A Fuel Cell,” to Roberts et al., which employs a reactant starvation technique to maintain reduced voltages in the fuel cell stack 104. Another technique to operate fuel cell stack 104 at reduced voltage is to draw DC current from the fuel cell stack 104 such that the operating point on the polarization curve corresponds to a reduced voltage. Any suitable apparatus and/or system that maintains reduced voltage in the fuel cell stack 104 during a cold-start condition may be used by the various embodiments.

In one exemplary embodiment, as the operating temperature of the fuel cell stack 104 increases to at least the minimum start-up operating temperature, the fuel cell and battery charger controller 112 causes the controller 122 to raise voltage of the fuel cell stack 104 to a normal operating voltage. In other embodiments, as temperature of the fuel cells 110 in the fuel cell stack increases, and as more fuel is supplied to the fuel cells 110, the polarization curve moves outward such that voltage of the fuel cell stack 104 increases. Accordingly, as temperature of the fuel cell stack 104 increases, the DC power supplied to the power conversion system 108 from the fuel cell stack 104 may increase.

In selected embodiments described herein, the fuel cell and battery charger controller 112 communicates control signals, via connection 138, directly to the converter 122. Residing in converter 122 are a plurality of power semiconductor devices, for example MOSFETs and/or IGBTs (not shown), that are operable in accordance with the received control signals to cause the fuel cell stack 104 to operate at the above-described reduced voltage. It is appreciated that alternative embodiments may accomplish the same or similar functionality in other manners. For example, the fuel cell and battery charger controller 112 may communicate control signals to other devices, such as switching devices coupled to a resistor, such that power is supplied to the resistor from the fuel cell such that the fuel cell stack 104 operates at the above-described reduced voltage during a cold-start condition. Alternatively, the above-described functionality of the fuel cell and battery charger controller 112 may be integrated into a multi-function controller (not shown) residing in the power conversion system 108 or in another suitable location. It is appreciated that the various possibilities of implementing the above-described functionality of the fuel cell and battery charger controller 112 may be performed by a multitude of control system apparatus and methods, and that such various apparatus and methods are too numerous to conveniently describe herein. It is intended that all such various apparatus and methods having the above-described functionality of the fuel cell and battery charger controller 112 are included within the scope of this disclosure.

Summarizing, the fuel cell and battery charger controller 112 receives temperature information from the temperature sensors 114, 116 to determine if the temperatures of the battery 106 and/or the fuel cell stack 104, respectively, are below their respective minimum start-up operating temperatures. If one or both of the sensed temperatures are below their respective minimum start-up operating temperature, a cold-start condition is determined to exist. If the cold-start condition is applicable to the battery 106, pulsating current, such as AC current in the exemplary embodiment described hereinabove, is supplied to the battery 106 such that the battery 106 operating temperature increases to at least its respective minimum start-up operating temperature. During a start-up process, the fuel cell stack 104 is started by adding fuel into the individual fuel cells (not shown) of the fuel cell stack 104. If the cold-start condition is applicable to the fuel cell stack 104, operating voltage of the fuel cell stack is maintained at a relatively low value such that the fuel cell stack 104 operating temperature increases to at least its respective minimum start-up operating temperature.

As the operating temperature of the battery 106 reaches at least its respective minimum start-up operating temperature, the AC current is removed from the battery 106. Similarly, as the operating temperature of the fuel cell stack 104 reaches at least its respective minimum start-up operating temperature, the operating voltage of the fuel cell stack 104 is allowed to rise. In alternative embodiments, AC current or other suitable pulsating current may be maintained on the battery 106, and/or the reduced voltage condition may be maintained on the fuel cell 104, to further increase operating temperatures to a threshold temperature or the like for either the battery 106 or the fuel cell stack 104.

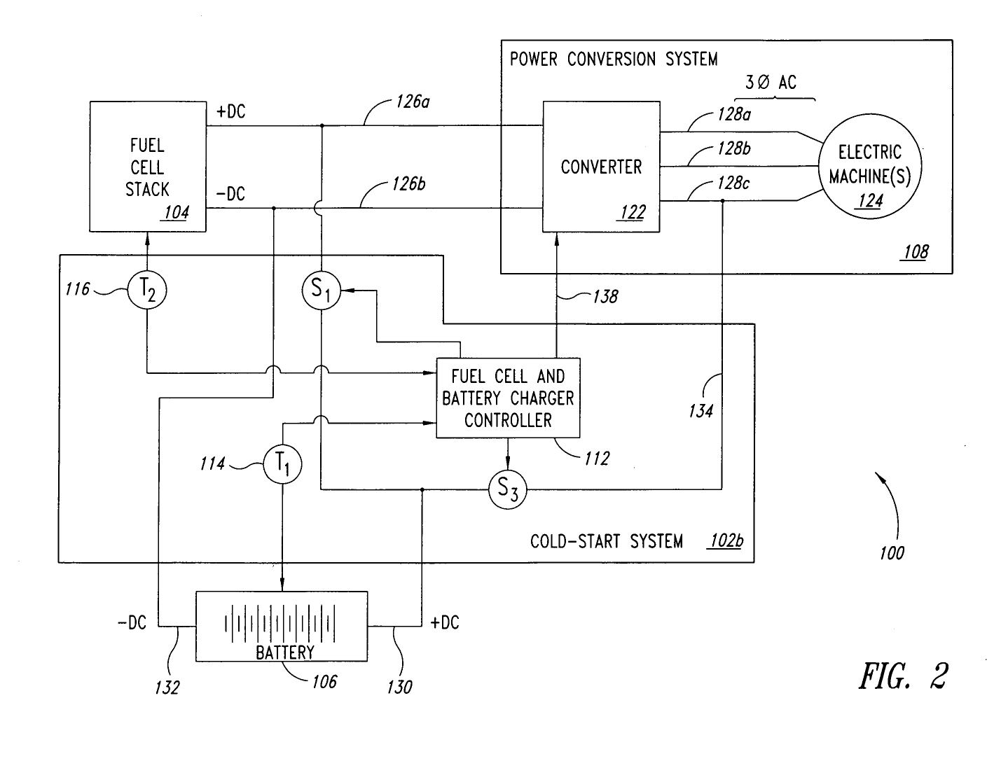

FIG. 2 is a block diagram of an alternative embodiment of a cold-start system 102b. The cold-start system 102b comprises a fuel cell and battery charger controller 112, a temperature sensor 114 operable to sense temperature of the battery 106 or proximate ambient temperature, a temperature sensor 116 operable to sense temperature of the fuel cell stack 104 or proximate ambient temperature, a first switch S1, and a second switch S3. The fuel cell and battery charger controller 112 is controllably coupled to the first switch S1 and the second switch S3 such that the fuel cell and battery charger controller 112 controls operation of the switches S1 and S3.

Similar to the above-described cold-start system 102a, when the sensed temperatures are below the respective minimum start-up operating temperature of the fuel cell stack 104 and/or the battery 106, respectively, a cold-start condition is determined to exist. The cold-start system 102b increases the operating temperature of fuel cell stack 104 and/or battery 106 during the cold-start condition by operating the fuel cell stack 104 at a reduced voltage and/or by providing AC current to the battery 106. Preferably, a pulsating current such as AC power is provided to battery 106 through a power conversion system 108 that is supplied, at least in part, by DC power generated by the fuel cell stack 104.

More specifically, in this exemplary embodiment, temperature sensor 114 may indicate that the operating temperature of the battery 106 is less than its minimum start-up operating temperature. In that event, the switch S3 is operated in a closed position to electrically couple the battery 106 to a source of AC current. Switch S1 is operated in an open condition to electrically decouple the positive terminal 130 of the battery 106 from the DC power portion of the power conversion system 108. In this exemplary embodiment, switch S3 is coupled to connection 128c, via connection 134.

Accordingly, AC current through battery 106 causes the battery operating temperature to increase. When the operating temperature of battery 106 increases to at least the minimum start-up operating temperature, the fuel cell and battery charger controller 112 causes switch S3 to open and switch S1 to close. Accordingly, the AC current is no longer provided to the battery 106, and the battery 106 becomes electrically coupled to the connections 126a and 126b such that normal operation of the battery 106 may occur, for example, sourcing or sinking current to or from the DC bus 126 based on operational conditions.

In alternative embodiments, the switch S3 may be electrically coupled to any of the AC connections 128a, 128b, or 128c. In other embodiments, switch S3 may be coupled to other AC connections (not shown) in the power conversion system 108. Such other AC connections may be providing power to other types of three-phase and/or single-phase type loads in the power conversion system 108.

As described above with respect to FIG. 1, temperature sensor 116 may concurrently indicate that the operating temperature of the fuel cell stack 104 is less than its respective minimum start-up operating temperature. In that event, the fuel cell stack 104 is operated in the above-described reduced voltage condition such that excess heat is generated as a result of the low operating efficiency induced by the reduced operating voltage of the fuel cell stack 104. For brevity, the process of increasing temperature of the fuel cell stack 104 during a determined cold-start condition is not described again.

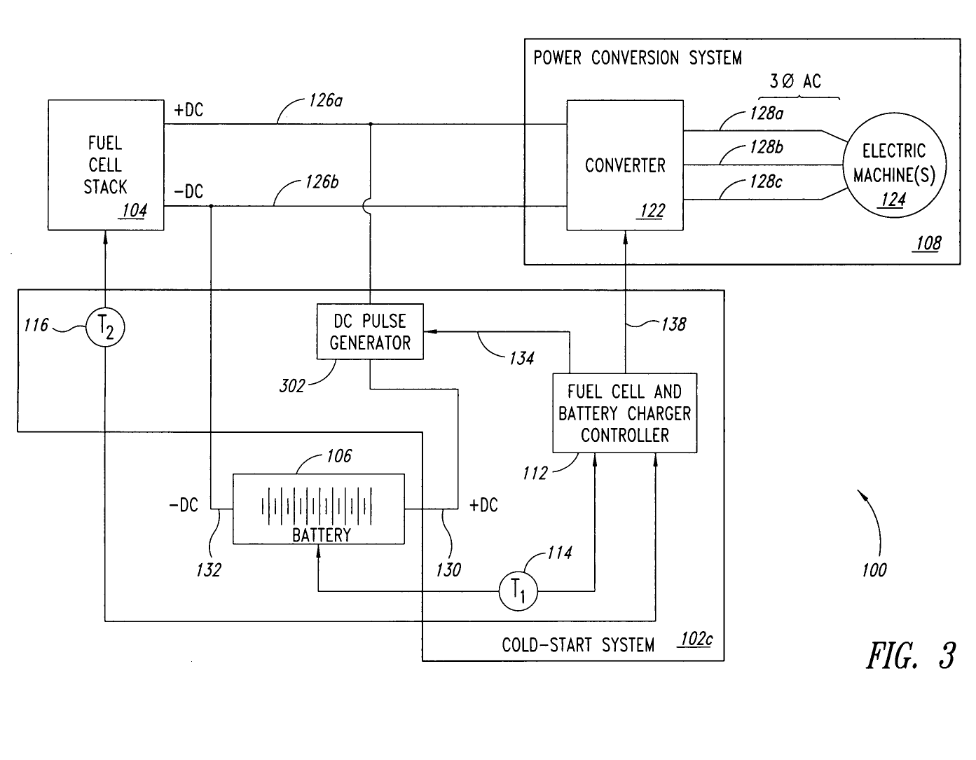

FIG. 3 is a block diagram of another alternative embodiment of a cold-start system 102c. The cold-start system 102c comprises a fuel cell and battery charger controller 112, a temperature sensor 114 operable to sense temperature of the battery 106 or proximate ambient temperature, a temperature sensor 116 operable to sense temperature of the fuel cell stack 104 or proximate ambient temperature, and a DC pulse generator 302. The fuel cell and battery charger controller 112 is controllably coupled to the DC pulse generator 302, via connection 134.

Similar to the above-described cold-start system 102a, when the sensed temperatures are below the respective minimum start-up operating temperature of the fuel cell stack 104 and/or the battery 106, respectively, the cold-start system 102c increases the operating temperature of fuel cell stack 104 and/or battery 106 during the cold-start condition by operating the fuel cell stack 104 at a reduced voltage and/or by providing a pulsed DC current to the battery 106. Preferably, pulsed DC power from the DC pulse generator 302 is provided to battery 106, at least in part, by DC power generated by the fuel cell stack 104.

More specifically, in this exemplary embodiment, temperature sensor 114 may indicate that the operating temperature of the battery 106 is less than its minimum start-up operating temperature. In that event, the DC pulse generator 302 is operated to generate pulsed DC current. Here, the pulsed DC current is tantamount to a form of AC current. Any suitable pulse shape may be used.

In this exemplary embodiment, the DC pulse generator 302 is coupled to connection 126a and the positive terminal 130 of battery 106. The pulsating current output from the DC pulse generator 302 is a pulsed DC current. The pulsed DC current flows into the positive terminal 130 of battery 106. The pulsed DC current then flows out of the negative terminal 132 of battery 106, and then returns to the connection 126b.

The pulsed DC current through battery 106 causes the battery operating temperature to increase. When the operating temperature of battery 106 increases to at least the minimum start-up operating temperature, the fuel cell and battery charger controller 112 causes the DC pulse generator 302 to provide a non-pulsed DC current to the battery 106.

This embodiment may be advantageous in that the frequency of the pulsed DC current provided by the DC pulse generator 302 is separately controllable. In contrast to the above-described embodiments of the cold-start system 102a and 102b (FIGS. 1 and 2, respectively), where the same AC frequency is provided to the loads and the battery (an electrical vehicle motor may operate at 0-600 Hz, typically), the pulse frequency may be adjusted to a frequency that is more optimal for heating of the battery 106.

In an alternative embodiment, the DC pulse generator 302 may comprise an internal by-pass switch (not shown) such that when the pulsed DC current applied to the battery 106 is ended or is not otherwise provided to battery 106, internal components in the DC pulse generator 302 which generate the pulsed DC current are bypassed. In yet another embodiment, the above described by-pass switch is a separate switching device external from the DC pulse generator 302.

A DC switch device could be pulsed by the fuel cell and battery charger controller 112, or may have an oscillator or the like to control the pulsing. For brevity, a detailed description of the numerous different types of DC pulse generator 302, and/or the by-pass switch if used, is not provided herein. It is intended that all such various types of DC pulse generator 302 and/or by-pass switch, which are too numerous to be conveniently described in detail herein, are included within the subject matter of this disclosure.

In above-described exemplary embodiment illustrated in FIG. 3, the DC pulse generator 302 is electrically coupled between connection 126a (+DC) and the positive DC terminal 130 of battery 106. In an alternative embodiment, the DC pulse generator 302 is electrically coupled between connection 126b (−DC) and the negative DC terminal 132 of battery 106. In yet other embodiments, DC pulse generator 302 may be electrically coupled to other DC sources in the power conversion system 108. In such configurations, the DC pulse generator 302 is still operable to cause the above-described pulsing of DC power through the battery 206 to cause internal heating during the cold-start condition.

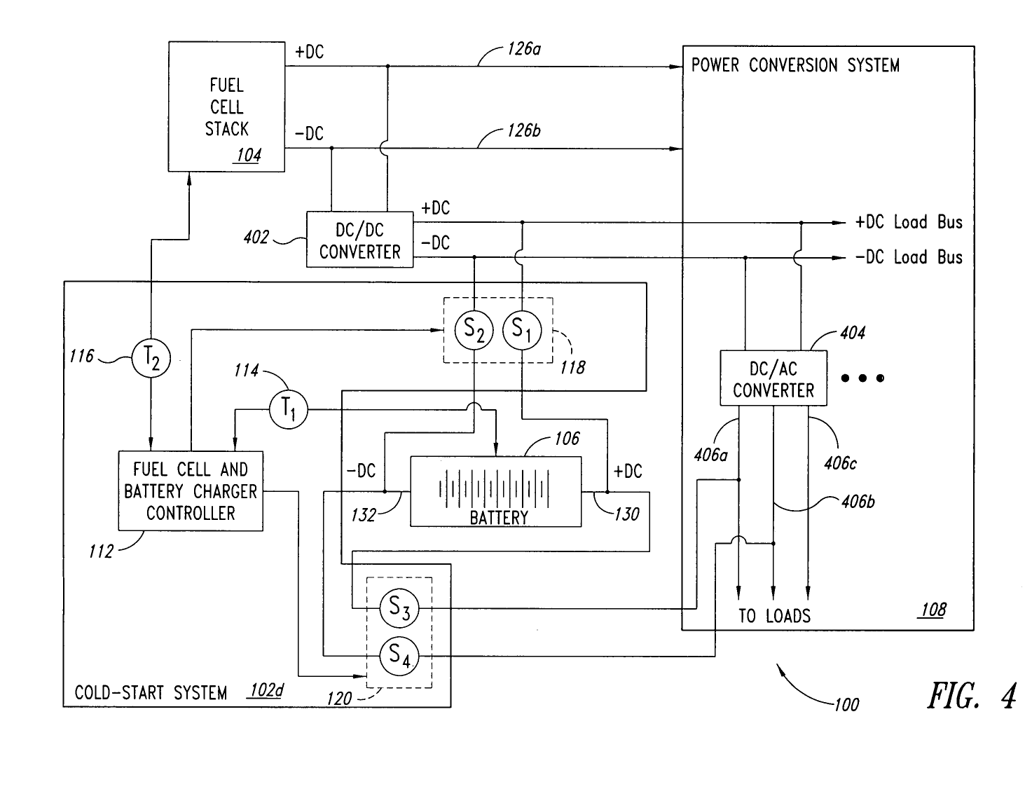

FIG. 4 is a block diagram of yet an alternative embodiment of a cold-start system 102d. In this exemplary embodiment, the operating voltage of the fuel cell 104 is different from the operating voltage of the battery 106. Accordingly, a direct current to direct current (DC/DC) converter 402 is employed to facilitate exchange of DC power between at least the fuel cell 104 and the battery 106. The DC/DC converter 402 is illustrated as a separate component for convenience. In various embodiments, the DC/DC converter 402 may reside in the power conversion system 108, and may perform other functions in addition to transferring DC power between the fuel cell stack 104 and the battery 106.

A direct current to alternating current (DC/AC) converter 404 is illustrated as residing in the power conversion system 108. The DC/AC converter 404 may reside in another convenient location, and/or may perform other functions in addition to transforming DC power in to AC power for supplying AC current, via connections 406a-c, to the battery 106 during a cold-start condition. For example, the DC/AC converter may transform AC power to DC power, such as when an electric machine is operating as a generator during regeneration braking. In the various embodiments, the switches S3 and/or S4 may be coupled to any of the AC connections 406a-c.

In principle, this exemplary alternative embodiment of the cold-start system 102d operates substantially similarly to the above-described embodiment of the cold-start system 102a (FIG. 1). Switches S1, S2, S3 and S4 are operated as described above to provide AC current to battery 106 during the cold-start condition. For brevity, the detailed description of the operation of this alternative embodiment of the cold-start system 102d is not repeated.

As a further alternative to the cold-start system 102d, the switches S2 and S4 may be omitted, thereby resulting in a configuration that is substantially similar to the above-described embodiment of the cold-start system 102b (FIG. 2). Switches S1 and S3 are operated as described above to provide AC current to battery 106 during the cold-start condition. For brevity, the detailed description of the operation of this alternative embodiment of the cold-start system 102d is not repeated.

As yet another alternative to the cold-start system 102d, the DC/DC converter 402 may be replaced with the above described DC pulse generator 302, thereby resulting in a configuration that is substantially similar to the above-described embodiment of the cold-start system 102c (FIG. 3). Alternatively, the DC/DC converter 402 itself may be operated to provide pulsed DC current to battery 106 during the cold-start condition. For brevity, the detailed description of the operation of these alternative embodiments of the cold-start system 102d is not further described.

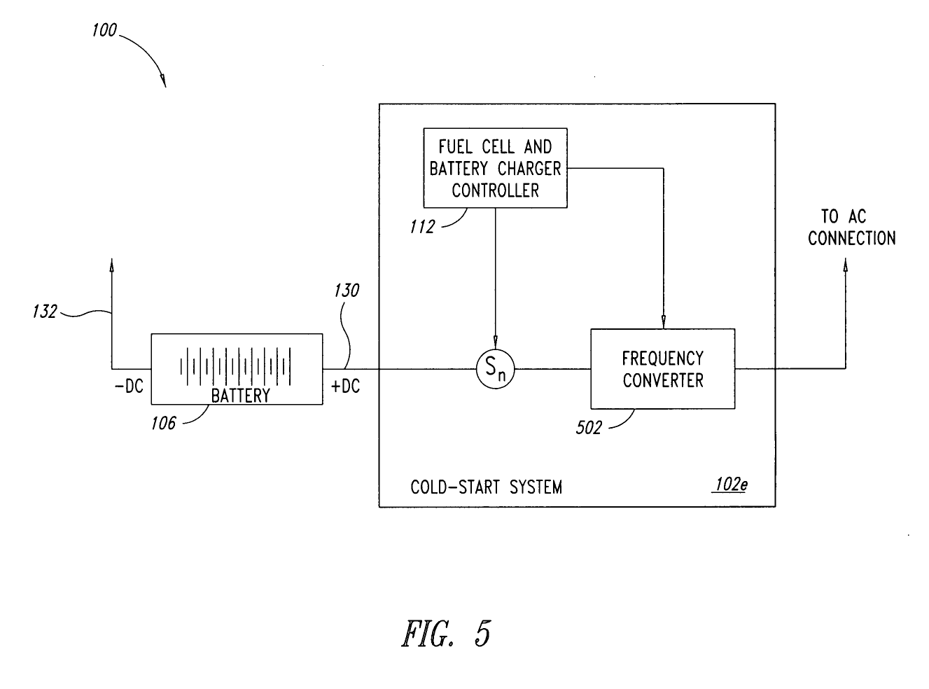

FIG. 5 is a block diagram of an alternative embodiment of a cold-start system 102e employing a frequency converter 502. As noted above, these embodiments may be advantageous in that the frequency of the pulsating current provided by the frequency converter 502 is separately controllable. In contrast to the above-described embodiments of the cold-start system 102a and 102b (FIGS. 1 and 2, respectively), where the same pulsating frequency may be provided to the battery and the loads, the frequency of the pulsating current provided by the frequency converter 502 may be adjusted to a frequency that is more optimal for heating of the battery 106.

For convenience, the output of the frequency converter 502 is illustrated as electrically coupled to switch Sn. Switch Sn, in one embodiment corresponding to the cold-start system 102b (FIG. 2), would correspond to switch S3. In another embodiment, switch Sn would correspond to the second set of switches 120 (S3 and S4) of the cold-start system 102a (FIG. 1). For brevity, the detailed description of the operation of this alternative embodiment of the cold-start system 102e is not repeated. Switch Sn may be coupled to any suitable connection that provides a source of AC current, such as illustrated in FIG. 1, 2 or 4.

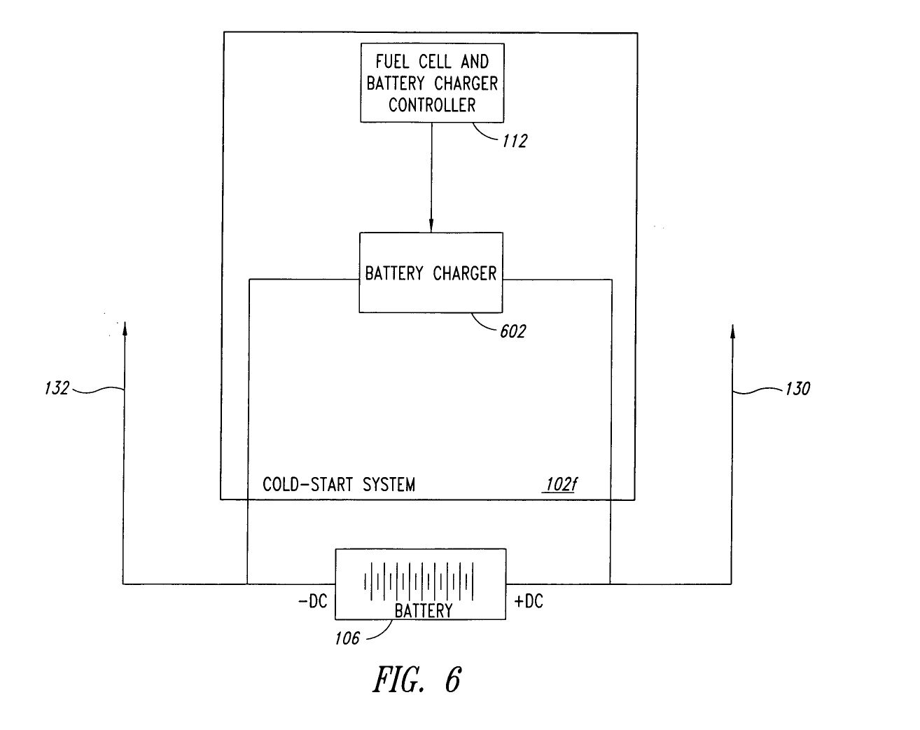

FIG. 6 is a block diagram of an alternative embodiment of a cold-start system 102f employing a battery charger 602. Battery charger 602 is operable to maintain charge of the battery 106. Battery charger 106 is coupled to a suitable power source (not shown) and transfers power to the battery 106 during a charging operation. The battery charger 602 is further operable, in response to signals from the fuel cell and battery charger controller 112, to provide the above-described pulsating current for heating the battery 106 during a cold-start condition.

Any suitable battery charger 602 may be employed. For example, the source of power used by the battery charger 602 may be controllable by the fuel cell and battery charger controller 112, such as when, but not limited to, a switch device or means is operated to provide the source power to the battery charger 602 in a pulsating manner. Alternatively, a switch device or means may be operable to control the output of the battery charger 602 in a pulsating manner. Or, battery charger 102f may be specially designed and operated to provide battery charging to the battery 106 during charging, and designed and operated to provide pulsating current for heating the battery 106 during a cold-start condition. In some embodiments, the fuel cell and battery charger controller 112 may be a component of the battery charger 602.

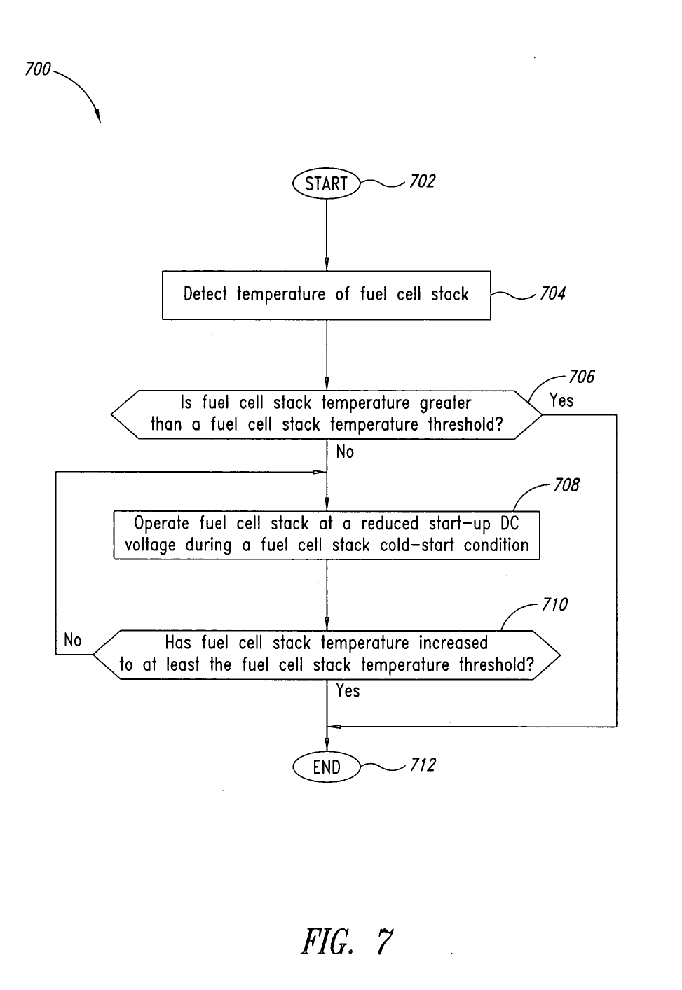

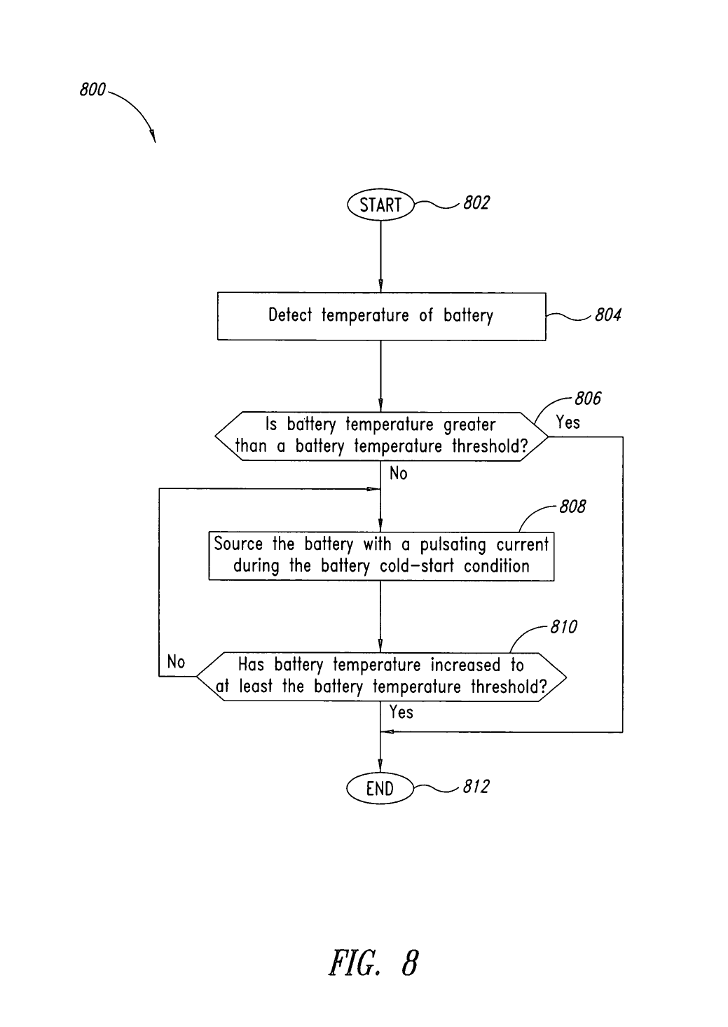

FIGS. 7 and 8 are flow charts 700 and 800, respectively, illustrating the operation of embodiments of the fuel cell and battery charger controller 112 (FIGS. 1-5). The flow charts 700 and 800 show the architecture, functionality, and operation of a possible implementation of software for implementing the fuel cell and battery charger controller 112. In this regard, each block may represent a module, segment, or portion of code, which comprises one or more executable instructions for implementing the specified logical function(s). It should also be noted that in some alternative implementations, the functions noted in the blocks may occur out of the order noted in FIGS. 7 and 8, may include additional functions, and/or may omit some functions. For example, two blocks shown in succession in FIGS. 7 and/or 8 may in fact be executed substantially concurrently, the blocks may sometimes be executed in the reverse order, or some of the blocks may not be executed in all instances, depending upon the functionality involved. Further, the processes of FIGS. 7 and 8 may be concurrently executed or may be serially executed during cold-start conditions. And, selective acts of the processes of FIGS. 7 and 8 could be integrated together in any suitable manner. All such modifications and variations are intended to be included herein within the scope of this disclosure.

The process illustrated in FIG. 7 starts at block 702. At block 704, temperature of the fuel cell stack 104 is detected. At block 706, a determination is made whether the temperature of the fuel cell stack 104 is greater than a fuel cell stack temperature threshold. If not (the “No” condition), the process proceeds to block 708 such that the fuel cell stack 104 is operated at the above-described reduced start-up DC voltage during the cold-start condition. Then, the process proceeds to block 710 where a determination is made whether the temperature of the fuel cell stack 104 has increased to at least the fuel cell stack temperature threshold. If not (the “No” condition), the process returns to block 608 to continue operation of the fuel cell stack 104 at the reduced start-up DC voltage.

However, if at block 710 the temperature of the fuel cell stack 104 has increased to at least the fuel cell stack temperature threshold (the “Yes” condition), the cold-start process for the fuel cell stack 104 ends at block 712. Similarly, if at block 706 the temperature of fuel cell stack 104 is greater that a fuel cell stack temperature threshold, the process proceeds to block 712 and ends.

The process illustrated in FIG. 8 starts at block 802. At block 804, temperature of the battery 106 is detected. At block 806, a determination is made whether the temperature of battery 106 is greater than a battery temperature threshold. If not (the “No” condition), the process proceeds to block 808 such that the battery 106 is sourced with the above-described pulsating current during the cold-start condition. Then, the process proceeds to block 810 where a determination is made whether the temperature of the battery 106 has increased to at least the battery temperature threshold. If not (the “No” condition), the process returns to block 808 to continue operation of the battery 106 with the pulsating current.

However, if at block 810 the temperature of the battery 106 has increased to the battery temperature threshold (the “Yes” condition), the cold-start process for the battery 106 ends at block 812. Similarly, if at block 806 the battery temperature is greater that the battery temperature threshold, the process proceeds to block 812 and ends.

The above-described embodiments illustrated in FIGS. 1, 2, and 4 provided the pulsating current to battery 106 as AC current. In some embodiments, AC current may be provided at a nominal operating frequency of the loads of the power system 100, such as at 60 hertz. Alternatively, the converters 122 and/or 404 may be operated at an off-nominal frequency during a cold-start condition. For example, but not limited to, auxiliary AC loads could be electrically decoupled from the converters 122 and/or 404 such that the converters 122 and/or 404 are operable at relatively high frequency (and/or at a suitable battery voltage). After the battery temperature rises to some threshold, or after a time delay or the like, the auxiliary AC loads could be electrically coupled to the converter output and the frequency adjusted to the nominal frequency for the AC loads.

In yet other embodiments, battery 106 may be electrically coupled to a DC connection, such as the output terminals of a DC/DC boost converter or a DC/DC buck converter. The DC/DC boost or buck converter could be operated to provide the pulsating current to the battery 106 during the cold-start condition, and then be operated in its designed boost/buck mode during normal operation. Further, the amplitude of the DC current output from the DC/DC converter and output to battery 106 could be modulated to provide the pulsed current to the battery 106. Also, a voltage suitable for the battery could be provided.

Different types of voltage and/or current conversions may occur in other embodiments of the power conversion systems 108. For example, converter 122 may be a single-feed, a dual-feed, or a multi-feed AC/DC converter.

In the above-described embodiments, at least a portion of the pulsating current supplied to the battery 106 during a cold-start condition is provided by the fuel cell stack 104. In alternative embodiments, the remaining portion, or the entire portion, of the pulsating current supplied to the battery 106 may be provided from alternative sources. For example, if the power system is employed in an electric vehicle wherein the above-described electric machines 124 are operable in a regenerative braking mode, the electric vehicle may be moved backward and then braked during a cold-start condition such that the electric machines 124 source all of, or a portion of, the pulsating current supplied to the battery 106. If ultra-capacitors and/or super capacitors are employed by the power system 100, power from the ultra-capacitors and/or super capacitors could source all of, or a portion of, the pulsating current supplied to the battery 106. In the above-described embodiments, the fuel cell and battery charger controller 112 may be a single purpose device for controlling the above-described sourcing of pulsating current to the battery 106 during a cold-start condition. In other embodiments, a dedicated battery charger or charging system may be employed to maintain charge on the battery 106 during normal operating conditions. In such embodiments, the battery charger or charging system may be operable to source pulsating current to the battery 106 during the cold-start condition. In yet other embodiments, the functions performed by the fuel cell and battery charger controller 112 may be performed by a controller that also performs other functions that may be related to the operation of the power system or to a vehicle in which the power system resides.

In the above-described various embodiments, the battery 106 was illustrated and described as a single battery. In other embodiments, a plurality of batteries may be electrically coupled together in a battery bank or the like, and/or located individually about the power system 100. In such embodiments, the provided AC current or the pulsed DC current may be provided to all of the batteries, or may be provided to one or more selected batteries.

Furthermore, some power systems 100 may have a plurality of different batteries used in various locations. In such situations, a plurality of cold-start system 102a-d may be used to provide AC current or the pulsed DC current to selected batteries. Or, a single cold-start system 102a-d may be used to provide AC current or the pulsed DC current to a plurality of batteries.

In the above-described various embodiments, the fuel cell and battery charger controller 112 (FIGS. 1-5) may employ a microprocessor, a digital signal processor (DSP), an application specific integrated circuit (ASIC) and/or a drive board or circuitry, along with any associated memory, such as random access memory (RAM), read only memory (ROM), electrically erasable read only memory (EEPROM), or other memory device storing instructions to control operation of the fuel cell and battery charger controller 112. Or, fuel cell and battery charger controller 112 may be implemented as a state machine or the like.

In the above-described various embodiments, the fuel cell stack 104 (FIG. 1) is understood to be comprised of a plurality of electrically coupled individual fuel cells 110. In alternative embodiments, individual fuel cells 110 of a fuel cell stack 104 may be individually controlled as described herein during a cold-start condition. Individually controlling a plurality of individual fuel cells 110 may be effected with a plurality of cold-start systems 102, or a single cold-start system 102 may control a plurality of individual fuel cells 110. Further, in some applications, a single fuel cell 110 may be controlled by a cold-start system 102. In some embodiments a power system may comprise more than one fuel cell stack. In these embodiments, some or all of the fuel cell stacks may be controlled as described herein during a cold-start condition.

In alternative embodiments, temperature sensor 116 is operable to sense temperature of a single fuel cell 110 (FIG. 1). Alternative embodiments may employ a plurality of temperature sensors 116 and/or 118 where the plurality of temperature sensors are communicatively coupled to the fuel cell and battery charger controller 112 or another suitable system operable to receive and/or analyze temperature information from the temperature sensors 116 and/or 118.

In alternative embodiments, other data may be used to determine the existence of a cold-start condition. For example, temperature sensors may be used to sense the temperatures of coolant fluid present in the power system or a vehicle in which the power system is housed. Temperature sensors may be used to sense the temperature of the ambient atmosphere of the power system. GPS (Global Positioning System) data may be used to determine the location of the power system, and tables used to determine the average temperatures at that location at that time of year. Timers may be used to determine the amount of time that has elapsed since the power system was last operated. It is appreciated that the various possibilities of determining the existence of a cold start condition may be performed by a multitude of apparatus and methods, and that such various apparatus and methods are too numerous to conveniently describe herein. It is intended that all such various apparatus and methods having the above-described functionality of determining the existence of a cold-start condition are included within the scope of this disclosure. The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein of the invention can be applied to other power conversion systems, not necessarily the exemplary power conversion system 108 embodiment generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

The various embodiments described above can be combined to provide further embodiments. All of the above U.S. patents, patent applications and publications referred to in this specification, including but not limited to: U.S. Pat. No. 6,329,089, entitled “Method and Apparatus For Increasing The Temperature Of A Fuel Cell,” to Roberts et al., are incorporated herein by reference, in their entirety, as are the sections in this specification. Aspects of the invention can be modified, if necessary, to employ systems, circuits and concepts of the various patents, applications and publications to provide yet further embodiments of the invention.

From the foregoing it will be appreciated that, although specific embodiments of the invention have been described herein for purposes of illustration, various modifications may be made without deviating from the spirit and scope of the invention. Aspects of the present systems and methods can be modified, if necessary, to employ systems, circuits and/or concepts of the various patents, applications and publications to provide yet further embodiments.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A power supply system operable during a cold-start condition, comprising:
a fuel cell stack electrically operable to produce direct current (DC) power;
a power conversion system electrically coupled to the fuel cell stack and operable to receive DC power from the fuel cell stack;
at least one battery electrically coupled to the power conversion system and operable to exchange battery DC power with the power conversion system; and
a controller at least operable to control operation of the power supply system such that at least an amount of pulsating current is supplied to the battery during the cold-start condition.

2. The system of claim 1 wherein the power conversion system comprises:
at least one converter operable to at least produce the pulsating current from the DC power received from the fuel cell stack and operable to provide the pulsating current to the battery during the cold-start condition.

3. The system of claim 2 wherein the power conversion system further comprises:
a frequency converter operable to adjust a frequency of the pulsating current supplied to the battery during the cold-start condition.

4. The system of claim 1 wherein the controller is operable to control operation of the fuel cell stack at a reduced voltage during the cold-start condition, and wherein the power conversion system comprises:
at least one converter operable to control a voltage of the fuel cell stack at the reduced voltage during the cold-start condition.

5. The system of claim 1, further comprising:
a battery temperature sensor communicatively coupled to the controller and operable to sense a temperature of the battery so that the controller determines an occurrence of the cold-start condition; and
a fuel cell temperature sensor communicatively coupled to the controller and operable to sense the temperature of the fuel cell stack so that the controller determines the occurrence of the cold-start condition.

6. The system of claim 1, further comprising:
at least one temperature sensor communicatively coupled to the controller and operable to sense an ambient temperature so that the controller determines an occurrence of the cold-start condition.

7. The system of claim 1, further comprising:
a DC connection coupled between the fuel cell stack and the power conversion system;
at least one alternating current (AC) connection residing in the power conversion system that is operable to source AC current to the battery during the cold-start condition;
a first switch coupled between the DC connection and the battery; and
a second switch coupled between the AC connection and the battery,
wherein during the cold-start condition the first switch is operated to electrically decouple the battery from the DC connection and the second switch is operated to electrically couple the battery to the AC connection so that AC current is supplied to the battery.

8. The system of claim 7 wherein during a normal operating condition the first switch is operated to electrically couple the battery to the DC connection and the second switch is operated to electrically decouple the battery from the AC connection.

9. The system of claim 7 wherein the first switch and the second switch are controllable by the controller such that the controller opens the first switch and closes the second switch in response to the cold-start condition, and such that the controller closes the first switch and opens the second switch in response to a conclusion of the cold-start condition.

10. The system of claim 1 wherein the power supply system further comprises:
a DC pulse generator that generates the pulsating current.

11. The system of claim 1 further comprising:
a battery charger electrically coupled to the at least one battery and controllably coupled to the controller, wherein the battery charger is operable to supply the pulsating current to the battery during the cold-start condition in response to a signal from the controller.

12. A method for operating a fuel cell stack and at least one battery during at least a cold-start condition, the method comprising:
operating the fuel cell stack at a reduced start-up direct current (DC) voltage during the cold-start condition so that excess heat generated within the fuel cell stack during the cold-start condition increases a temperature of the fuel cell stack, wherein the reduced start-up DC voltage is less than a nominal DC voltage received from the fuel cell stack during a normal operating condition; and
sourcing the at least one battery with pulsating current during the cold-start condition so that excess heat generated within the battery during the cold-start condition increases a temperature of the battery, wherein DC power from the fuel cell stack is converted into at least a portion of the pulsating current sourced to the battery.

13. The method of claim 12, further comprising:
sensing the temperature of the battery;
determining an occurrence of the cold-start condition in response to the temperature of the battery being less than a battery temperature threshold.

14. The method of claim 12, further comprising:
sensing the temperature of the fuel cell stack;
determining an occurrence of the cold-start condition in response to the temperature of the fuel cell stack being less than a fuel cell stack temperature threshold.

15. The method of claim 12, further comprising:
opening a first switch coupled between a positive direct current (+DC) connection of the fuel cell stack and a +DC connection of the battery; and
closing a second switch coupled between an AC connection and the +DC connection of the battery so that the battery is sourced with the pulsating current during the cold-start condition.

16. The method of claim 15, further comprising:
closing the first switch at a conclusion of the cold-start condition; and
opening the second switch at the conclusion of the cold-start condition.

17. The method of claim 12, further comprising:
receiving DC current from the fuel cell stack during the cold-start condition; and
converting the received DC current into the pulsating current.

18. The method of claim 12 wherein sourcing the battery with pulsating current comprises:
sourcing the battery with the pulsating current provided by a DC pulse generator.

19. The method of claim 12 wherein sourcing the battery with pulsating current comprises:
adjusting a frequency of the pulsating current using a frequency converter.

20. The method of claim 12, further comprising:
sourcing a second battery with a portion of the pulsating current during the cold-start condition so that excess heat generated within the second battery during the cold-start condition increases a temperature of the second battery, wherein DC power from the fuel cell stack is converted into at least a portion of the pulsating current sourced to the second battery.

21. A method for operating a fuel cell stack and at least one battery during at least a cold-start condition, the method comprising:
receiving direct current from at least one fuel cell of the fuel cell stack during the cold-start condition;
converting at least a portion of the received direct current into pulsating current; and
providing the pulsating current to the battery during at least a portion of the cold-start condition so that excess heat is generated within the battery during the cold-start condition to increase a temperature of the battery.

22. The method of claim 21, further comprising:
reducing a voltage of the at least one fuel cell during the cold-start condition, wherein the reduced voltage is less than a nominal DC voltage of the fuel cell during a normal operating condition; and
where, in response to reducing the voltage of the fuel cell, generating the excess heat within the fuel cell during the cold-start condition to increase the temperature of the fuel cell.

23. The method of claim 21, further comprising:
providing a portion of the pulsating current to a second battery during the cold-start condition so that excess heat is generated within the second battery during the cold-start condition to increase a temperature of the second battery.

24. A system for operating a fuel cell stack and at least one battery during at least a cold-start condition, the method comprising:
means for operating the fuel cell stack at a reduced start-up direct current (DC) voltage during the cold-start condition so that excess heat generated within the fuel cell stack during the cold-start condition increases a temperature of the fuel cell stack, wherein the reduced start-up DC voltage is less than a nominal DC voltage received from the fuel cell stack during a normal operating condition;
means for receiving a direct current from the fuel cell stack during the cold-start condition;
means for converting at least a portion of the received DC current into alternating current; and
means for providing the alternating current to the battery during at least a portion of the cold-start condition so that excess heat is generated within the battery during the cold-start condition to increase a temperature of the battery.

25. The system of claim 24, further comprising:
means for adjusting a frequency of the alternating current.

26. The system of claim 23 wherein the means for providing the alternating current to the battery comprises:
means for providing a non-sinusoidal alternating current to the battery.
